(19) United States
(12) Patent Application Publication
(10) Pub. No.: US 2024/0254799 A1
(43) Pub. Date: Aug. 1, 2024

(54) Lighted Gravesite Blanket

(71) Applicant: Charles Cribbs, Romulus, MI (US)

(72) Inventor: Charles Cribbs, Romulus, MI (US)

(21) Appl. No.: 18/359,263

(22) Filed: Jul. 26, 2023

Related U.S. Application Data
(60) Provisional application No. 63/442,553, filed on Feb. 1, 2023.

(51) Int. Cl. E04H 13/00; F21S 9/03; F21V 21/08

(52) U.S. Cl. CPC E04H 13/001; F21S 9/037; F21V 21/0824

(57) ABSTRACT

A lighted gravesite blanket to provide illumination and decoration to a gravesite is disclosed. The blanket is generally rectangular or square in shape, made of artificial pine branches or other materials, and sized to cover a gravesite area or burial plot area. The blanket features rows of solar-powered fiber optic lights woven into the top surface thereof to provide a powerful and consistent source of light in dark and low-light. Additionally, detachable stake lights and other decorative items can be positioned on the top surface for further personalization and additional illumination. The blanket is fastened securely to the ground using the stake lights and fasteners, and the lights are powered by solar energy, making it a sustainable and cost-effective solution. The lighted gravesite blanket is reusable and provides a unique way to add illumination and beauty to an otherwise gloomy gravesite and to offer a tribute to loved ones.

### CROSS-REFERENCE TO RELATED APPLICATION

The present application claims priority to, and the benefit of, U.S. Provisional Application No. 63/442,553, which was filed on Feb. 1, 2023, and is incorporated herein by reference in its entirety.

### FIELD OF THE INVENTION

The present invention generally relates to the field of gravesite blankets. More specifically, the present invention relates to a novel lighted gravesite blanket that provides illumination and is reusable. The blanket has solar powered fiber optic lights to help ease the gloominess of the graveyard and bring a sense of beauty and light. The gravesite blanket can be customized as per user requirements. Accordingly, the present disclosure makes specific reference thereto. Nonetheless, it is to be appreciated that aspects of the present invention are also equally applicable to other like applications, devices, and methods of manufacture.

### BACKGROUND

By way of background, gravesite blankets are a type of memorial decoration used for covering gravesites, oftentimes during the winter months. Gravesite blankets are typically made from evergreen branches, pinecones, and other natural materials arranged in a flat, rectangular shape that covers the grave. Gravesite blankets are also used for honoring the memory of a loved one during the holiday season while also protecting the gravesite from winter weather. However, conventional gravesite blankets are heavy, become unusable in subsequent years and are boring. They lack beauty and are plain. As a result, individuals are required to purchase a new gravesite blanket every year which is expensive and inconvenient. Individuals desire reusable gravesite blankets that eliminate the need to purchase fresh gravesite blankets each year.

Also, gravesites are gloomy and lack beauty. Gravesites are often marked with simple headstones or markers, which can be austere and lacking in ornamentation. The overall atmosphere of a cemetery can also contribute to the perception of gloominess. Conventional gravesite blankets do not add beauty to the gravesites. Individuals desire improved gravesite blankets that can improve aesthetics of the gravesites.

Further, gravesites are generally not illuminated, as there is no artificial lighting installed specifically to light up the area around the gravesites. This makes it difficult for individuals to see or navigate the area after dark, especially in cemeteries that do not have streetlights or other sources of ambient light nearby. Some individuals may bring battery-operated candles or lanterns to place at the gravesite, or other portable lighting solutions. However, these methods are not always practical or reliable, especially if the cemetery is far from the person's home or if the lighting needs frequent maintenance or replacement. Individuals desire a device that can provide illumination on gravesites in addition to improving aesthetics.

Conventional gravesite blankets are made of natural materials which can contribute to deforestation and other ecological issues. As a result, they create additional waste and litter. Individuals desire improved gravesite blankets that are made of artificial materials.

Therefore, there exists a long-felt need in the art for a gravesite blanket that is reusable and eliminates the need to purchase fresh gravesite blankets each year. There is also a long-felt need in the art for an improved gravesite blanket that is illuminated for providing illumination on gravesites. Additionally, there is a long-felt need in the art for a gravesite blanket that improves aesthetics and beauty of gravesites. Moreover, there is a long-felt need in the art for a gravesite blanket that is made of artificial material and does not create additional waste and litter. Further, there is a long-felt need in the art for a gravesite blanket that can be customized to suit different personalities and styles. Furthermore, there is a long-felt need in the art for a gravesite blanket that helps ease the gloominess of the graveyard and provides a more aesthetically pleasing grave display. Finally, there is a long-felt need in the art for an improved gravesite blanket that affords users a way to bring a sense of beauty and light to an otherwise gloomy setting.

The subject matter disclosed and claimed herein, in one embodiment thereof, comprises a lighted gravesite blanket for decorating and illuminating a gravesite. The gravesite blanket is comprised of a rectangular or square blanket made of artificial pine branches or other artificial materials and that is sized to cover a grave or burial area/plot. The blanket is comprised of a top surface and a bottom surface, a plurality of rows of solar-powered fiber optic lights woven into the top surface of the blanket, configured to absorb solar light and provide a consistent source of light to ease the gloominess of the graveyard and provide an aesthetically pleasing grave display, and various color options and decorative materials for personalization.

In this manner, the gravesite blanket of the present invention accomplishes all of the foregoing objectives and provides users with gravesite blankets that are illuminated using solar powered fiber optic tips. The blanket is reusable and eliminates the need to purchase fresh gravesite blankets each year. Further, the blanket can be customized to suit different personalities and styles and helps ease the gloominess of the graveyard and provide a more aesthetically pleasing grave display.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a lighted gravesite blanket for decorating and illuminating a gravesite. The gravesite blanket helps ease the gloominess of the graveyard and provides a more aesthetically pleasing grave display. The gravesite blanket further comprising a generally rectangular or square blanket having a top surface and a bottom surface, a pair of opposing longitudinal edges and a pair of opposing lateral edges, artificial pine branches and other artificial decorative items integrated into the top surface of the blanket for stability and decoration, a plurality of stake lights detachably positioned on the top surface along the longitudinal edges of the blanket for additional decoration, wherein the stake lights are solar powered, a plurality of rows of solar-powered fiber optic lights woven into the top surface of the blanket for providing illumination in low-light conditions, wherein the fiber optic lights are configured to absorb solar light for creating electric power and illuminating in multiple colors and forms, and one or more fasteners located on the bottom surface of the blanket for securing the blanket onto the gravesite, or burial area/plot, without requiring tools or effort.

In yet another embodiment, the artificial pine branches and other artificial decorative items are made of durable and weather-resistant materials, such as plastic or PVC, for long-lasting use and easy maintenance.

In a further embodiment, the plurality of rows of solar-powered fiber optic lights are arranged parallel to the longitudinal edges across the lateral edges.

In yet another embodiment, the plurality of rows of solar-powered fiber optic lights are arranged in a pattern on the top surface of the blanket, such as a cross, a heart, or any other conventional shape for added aesthetic appeal and personalization.

In one embodiment, the top surface of the blanket has a personalized logo or indicia.

In a further embodiment, a method for decorating and illuminating a gravesite is described. The method includes the steps of providing an illuminating gravesite blanket, the blanket having a top surface and a bottom surface, a plurality of rows of solar-powered fiber optic lights woven into the top surface of the blanket for providing illumination, placing the selected gravesite blanket over the grave or burial area/plot with the top surface facing upward, fastening the blanket to the ground using fasteners for secure installation on the gravesite, detachably positioning one or more stake lights and other decorative items on the top surface of the blanket, and illuminating the solar-powered fiber optic lights and stake lights during low light conditions for providing illumination and beauty to the grave.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of lighted gravesite blanket of the present invention in accordance with the disclosed architecture;

FIG. 2 illustrates an enlarged view of an exemplary stake light used in the lighted gravesite blanket of the present invention in accordance with the disclosed architecture;

FIG. 3 illustrates a perspective view of the lighted gravesite blanket of the present invention covering a gravesite, or a majority of a burial plot area, in accordance with the disclosed architecture;

FIG. 4 illustrates a flow diagram depicting a process of using the improved gravesite blanket of the present invention in accordance with the disclosed architecture; and

FIG. 5 illustrates a perspective of another embodiment of the lighted gravesite blanket of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a gravesite blanket that is reusable and eliminates the need to purchase fresh gravesite blankets each year. There is also a long-felt need in the art for an improved gravesite blanket that is illuminated for providing illumination on gravesites. Additionally, there is a long-felt need in the art for a gravesite blanket that improves aesthetics and beauty of gravesites. Moreover, there is a long-felt need in the art for a gravesite blanket that is made of artificial material and does not create additional waste and litter. Further, there is a long-felt need in the art for a gravesite blanket that can be customized to suit different personalities and styles. Furthermore, there is a long-felt need in the art for a gravesite blanket that helps ease the gloominess of the graveyard and provides a more aesthetically pleasing grave display. Finally, there is a long-felt need in the art for an improved gravesite blanket that affords users a way to bring a sense of beauty and light to an otherwise gloomy setting.

The present invention, in one exemplary embodiment, is a method for decorating and illuminating a gravesite. The method includes the steps of providing an illuminating gravesite blanket, the blanket having a top surface and a bottom surface, a plurality of rows of solar-powered fiber optic lights woven into the top surface of the blanket for providing illumination, placing the selected gravesite blanket over the grave with the top surface facing upward, fastening the blanket to the ground using fasteners for secure installation on the gravesite, detachably positioning one or more stake lights and other decorative items on the top surface of the blanket, and illuminating the solar-powered fiber optic lights and stake lights during low light conditions for providing illumination and beauty to the grave.

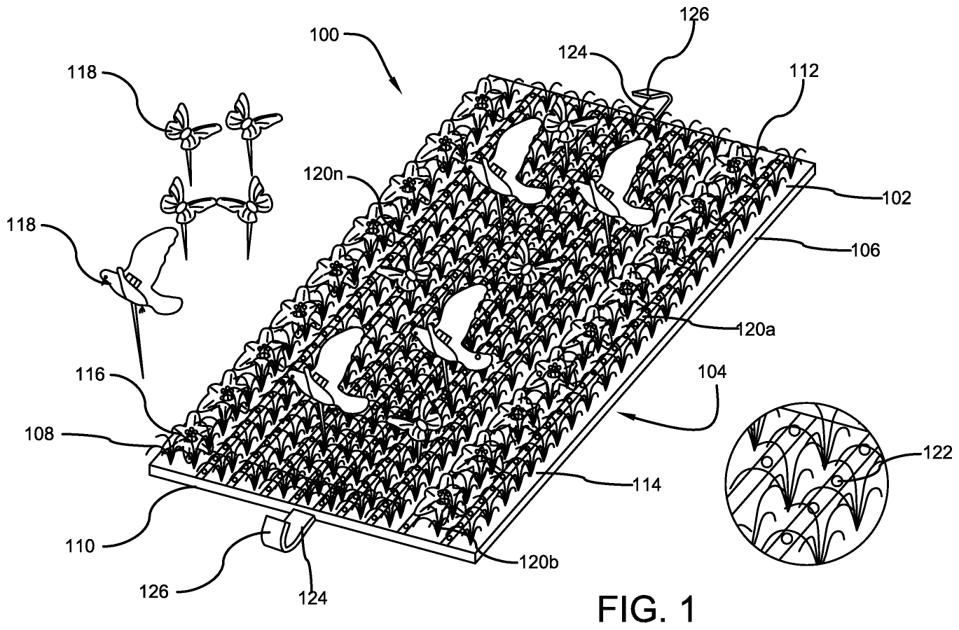

Referring initially to the drawings, FIG. 1 illustrates a perspective view of one potential embodiment of lighted gravesite blanket of the present invention in accordance with the disclosed architecture. The lighted gravesite blanket 100 of the present invention is designed as an improved gravesite blanket used for decorating and illuminating a gravesite in addition to covering the gravesite or burial area/plot. More specifically, the gravesite blanket 100 is a generally rectangular or square blanket having a top surface 102 and a bottom surface 104 and is designed to fit neatly over a gravesite or burial area/plot, covering the entire burial plot and creating a flat surface. The blanket 100 has a pair of opposing longitudinal edges 106, 108 and a pair of opposing lateral edges 110, 112. It should be noted that the exact structure and shape of the gravesite blanket 100 can vary depending on personal preference and the materials used.

The top surface 102 has artificial pine branches 114 and other artificial decorative items 116 positioned thereon. The artificial pine branches 114 and other artificial decorative items 116 are integrated to the top surface 102, thus they do not blow in the wind and provide stability to the blanket 100. A plurality of stake lights 118 are detachably positioned along the edges 106, 108 for providing additional decoration. The plurality of stake lights 118 are solar powered and can be in different decorative forms including, but not limited to, flowers, leaves, and more. These stake lights 118 can be small and unobtrusive, or alternatively can be larger and more decorative, depending on personal preference.

For providing adequate illumination on the gravesite, a plurality of rows 120a-n of solar-powered fiber optic lights 122 are woven into the top surface 102. The solar-powered fiber optic lights 122 are configured to absorb solar light for creating electric power. The electric power is used for creating a subtle yet powerful source of light that illuminates in low-light conditions by the solar-powered fiber optic lights 122. The solar-powered fiber optic lights 122 can illuminate in multiple colors and in any form, such as in a running or flashing manner. The lights 122 help ease the gloominess of the graveyard and provide a more aesthetically pleasing grave display.

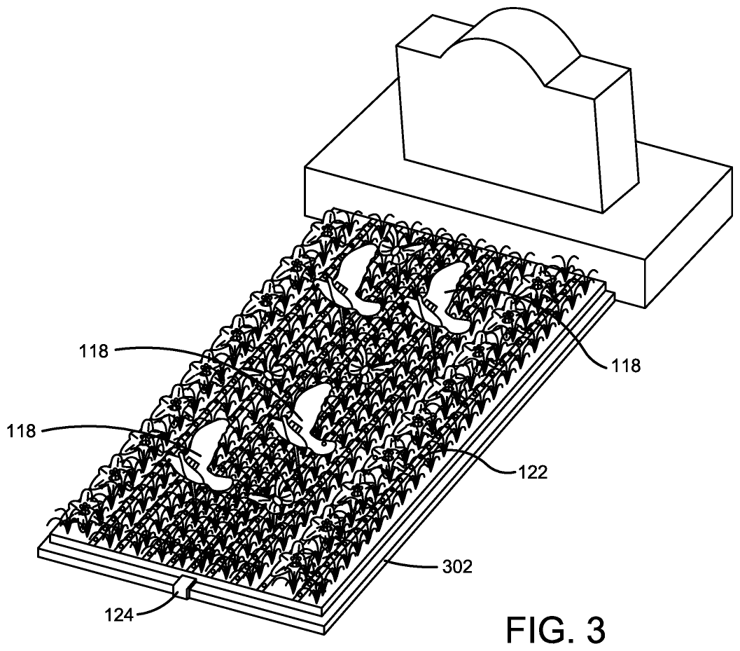

For securing the blanket 100 on a gravesite, or burial plot, as illustrated in FIG. 3, the bottom surface 104 of the blanket 100 has one or more fasteners 124 that can be fastened into the ground for securing the blanket 100 on the gravesite. The fasteners 124 can be any mechanical fastener having hooks, stakes, or anchors 126 which can be easily anchored to the ground without requiring any tools or effort.

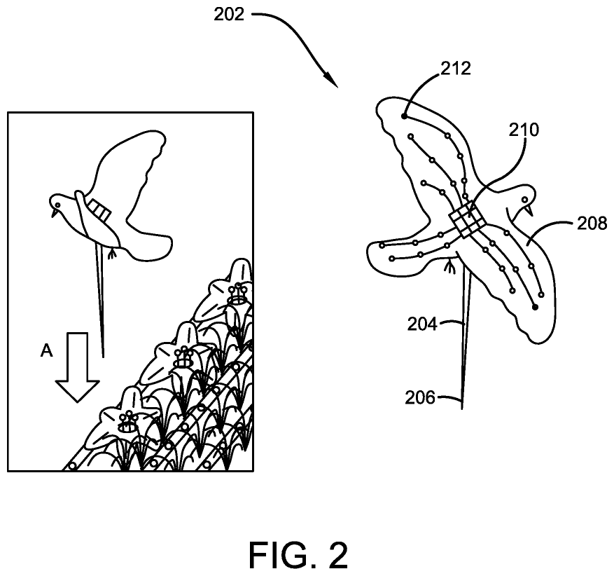

FIG. 2 illustrates an enlarged view of an exemplary stake light used in the lighted gravesite blanket of the present invention in accordance with the disclosed architecture. In the gravesite blanket 100, a plurality of stake lights 118 are used for providing decoration, illumination, and stabilization. As illustrated, an exemplary stake light 202 has a stake 204 having a pointed end 206 which can be easily pushed (Arrow A) into and through (i.e., piercing) the blanket 100, and then into the ground for detachably attaching the stake light 202 to the blanket 100 and for anchoring same to the ground. The stake light 202 has a decorative shaped body 208 including a solar cell 210 for absorbing solar light and converting it into electric power. A plurality of LEDs 212 are coupled to the solar cell 210 for providing illumination. The LEDs 212 can provide illumination in either one or multiple colors and are independent of the solar-powered fiber optic lights 122 of the lighted gravesite blanket 100.

The stake lights 118 can be made of plastic, polymer, rubber, or any other similar material. Further, the stake lights 118 can be made in any form, shape, and size and are made commercially available with the blanket 100. The stake 204 can be made of stainless steel, iron, or other similar metals. The shaped body 208 can be made of silk, polyvinyl chloride, acrylonitrile butadiene styrene, or any other similar material.

FIG. 3 illustrates a perspective view of the lighted gravesite blanket of the present invention covering a gravesite, or a majority of a burial plot area, in accordance with the disclosed architecture. The gravesite blanket 100 is designed to completely cover the gravesite 302 for honoring the deceased while providing illumination and beauty to the gravesite 302. As illustrated, the gravesite 302 is completely covered by the gravesite blanket 100 and the blanket 100 is illuminated due to illumination of the solar-powered fiber optic lights 122 and the stake lights 118. The gravesite blanket 100 is secured using the fasteners 124 fastened into the ground or gravesite 302 which prevents movement of the blanket 100 while being installed on the gravesite 302.

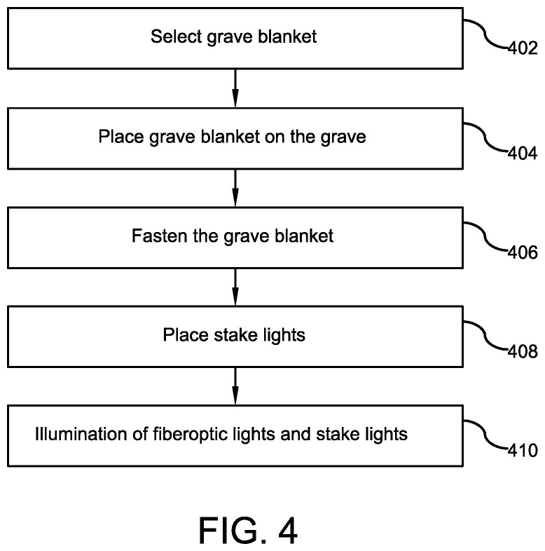

FIG. 4 illustrates a flow diagram depicting a process of using the improved gravesite blanket of the present invention in accordance with the disclosed architecture. Initially, a gravesite blanket corresponding to a size of the gravesite or burial plot, and preferences of users is chosen for covering the gravesite (Step 402). Then, the blanket is put on the gravesite with the top surface 102 of the gravesite blanket 100 facing upward (Step 404). Thereafter, the blanket is fastened to the ground using the fasteners for secure installation of the blanket on the gravesite (Step 406). Then, one or more stake lights 118 and other decorative items are detachably positioned on the top surface of the blanket for decorative and illumination purposes (Step 408). Finally, the solar-powered fiber optic lights 122 and stake lights 118 are illuminated during low light for providing illumination and beauty to the grave (Step 410).

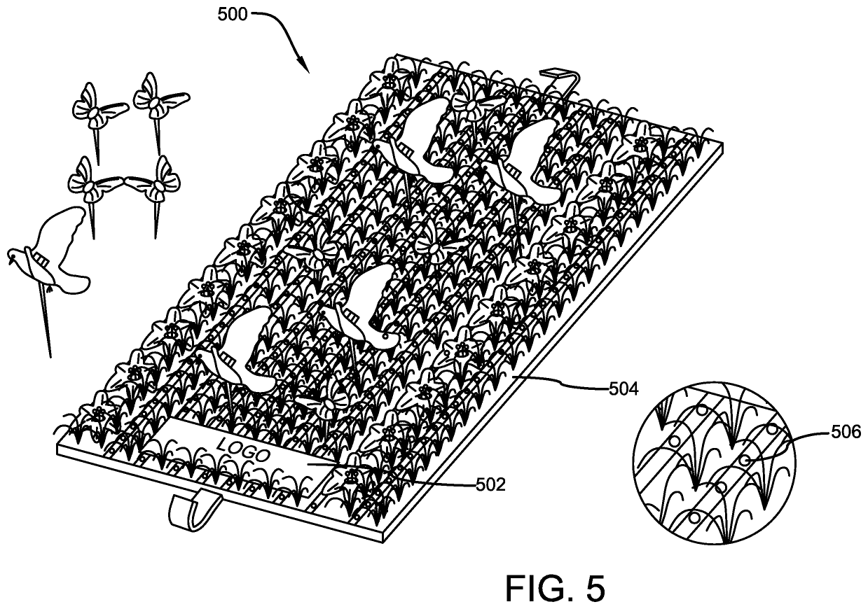

FIG. 5 illustrates a perspective of another embodiment of the lighted gravesite blanket of the present invention in accordance with the disclosed architecture. In the present embodiment, the gravesite blanket 500 has a personalized logo 502 on the top surface 504 thereof. The top surface 504 has a plurality of solar-powered fiber optic lights 506 woven into the top surface 504 in a shape including, but not limited to, heart, grid, cross, and more. All other specifications of the blanket 500 are similar to the blanket 100 described in other embodiments of the present invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved gravesite blanket”, “gravesite blanket”, “lighted gravesite blanket”, “solar-powered gravesite blanket”, and “blanket” are interchangeable and refer to the solar-powered illuminating gravesite blanket 100, 500 of the present invention.

Notwithstanding the foregoing, the solar-powered illuminating gravesite blanket 100, 500 of the present invention can be of any suitable size and configuration as is known in the art without affecting the overall concept of the invention, provided that it accomplishes the above-stated objectives. One of ordinary skill in the art will appreciate that the solar-powered illuminating gravesite blanket 100, 500 as shown in the FIGS. are for illustrative purposes only, and that many other sizes and shapes of the solar-powered illuminating gravesite blanket 100, 500 are well within the scope of the present disclosure. Although the dimensions of the solar-powered illuminating gravesite blanket 100, 500 are important design parameters for user convenience, the solar-powered illuminating gravesite blanket 100, 500 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gravesite blanket for illuminating a burial plot, the gravesite blanket comprising:
an illuminated blanket having a top surface, a bottom surface, a pair of opposing longitudinal edges, a pair of opposing lateral edges, a plurality of decorative items, a plurality of stake lights, and a plurality of optic lights;
wherein said plurality of decorative items are integrated to said top surface;
wherein said plurality of stake lights are detachably attached to said illuminated blanket;
wherein said plurality of stake lights are solar-powered lights for absorbing solar light to generate electric power;
wherein said plurality of stake lights having a stake including a pointed end for piercing said illuminated blanket and a ground surface, and staking said illuminated blanket to the ground surface; and
further wherein said plurality of optic lights woven into said top surface.

2. The gravesite blanket for illuminating a burial plot of claim 1, wherein said plurality of optic lights are solar-powered fiber optic lights for absorbing solar light to generate electric power.

3. The gravesite blanket for illuminating a burial plot of claim 2, wherein said bottom surface having at least one fastener for anchoring said illuminated blanket to the ground surface.

4. The gravesite blanket for illuminating a burial plot of claim 3, wherein said stake lights having a shaped body comprising a material selected from a group consisting of a plastic, polymer, and rubber.

5. The gravesite blanket for illuminating a burial plot of claim 4, wherein said stake lights having a stake comprising a material selected from a group consisting of a stainless steel, and an iron.

6. The gravesite blanket for illuminating a burial plot of claim 3, wherein said stake lights having a shaped body comprising a material selected from a group consisting of a silk, a polyvinyl chloride, and an acrylonitrile butadiene styrene.

7. A gravesite blanket for illuminating a burial plot, the gravesite blanket comprising:
an illuminated blanket having a top surface, a bottom surface, a pair of opposing longitudinal edges, a pair of opposing lateral edges, a plurality of decorative items, a plurality of stake lights, and a plurality of optic lights;
wherein said plurality of decorative items are integrated to said top surface;
wherein said plurality of stake lights are detachably attached to said illuminated blanket;
wherein said plurality of stake lights are solar-powered lights for absorbing solar light to generate electric power;
wherein said plurality of stake lights having a stake including a pointed end for piercing said illuminated blanket and a ground surface, and staking said illuminated blanket to the ground surface; and
further wherein said bottom surface having at least one fastener for anchoring said illuminated blanket to the ground surface.

8. The gravesite blanket for illuminating a burial plot of claim 7, wherein said plurality of optic lights are solar-powered fiber optic lights for absorbing solar light to generate electric power.

9. The gravesite blanket for illuminating a burial plot of claim 8, wherein said plurality of optic lights woven into said top surface.

10. The gravesite blanket for illuminating a burial plot of claim 9, wherein said stake lights having a shaped body comprising a material selected from a group consisting of a plastic, polymer, and rubber.

11. The gravesite blanket for illuminating a burial plot of claim 10, wherein said stake lights having a stake comprising a material selected from a group consisting of a stainless steel, and an iron.

12. The gravesite blanket for illuminating a burial plot of claim 9, wherein said stake lights having a shaped body comprising a material selected from a group consisting of a silk, a polyvinyl chloride, and an acrylonitrile butadiene styrene.

13. A method for illuminating a burial plot, the method comprising the steps of:
providing an illuminated blanket having a top surface, a bottom surface, a perimeter edge, a plurality of decorative items, a plurality of stake lights, and a plurality of optic lights, wherein said plurality of decorative items are integrated to said top surface;
placing said illuminated blanket over the burial plot with said top surface facing upwards;
piercing said illuminated blanket with spaced apart said plurality of stake lights;
staking said illuminated blanket with pointed ends of said plurality of stake lights inserted into the ground, wherein said plurality of stake lights are detachably attached to said illuminated blanket, and further wherein said plurality of stake lights are solar-powered lights; and
absorbing solar light with said plurality of stake lights to generate electric power.

14. The method for illuminating a burial plot of claim 13 further comprising a step of weaving said plurality of optic lights into said top surface of said illuminated blanket.

15. The method for illuminating a burial plot of claim 14, wherein said plurality of optic lights are solar-powered fiber optic lights for absorbing solar light to generate electric power.

16. The method for illuminating a burial plot of claim 15, wherein said bottom surface having at least one fastener for anchoring said illuminated blanket to the ground.

17. The method for illuminating a burial plot of claim 16, wherein said at least one fastener is a hook.

18. The method for illuminating a burial plot of claim 17, wherein said stake lights having a shaped body comprising a material selected from a group consisting of a plastic, polymer, and rubber.

19. The method for illuminating a burial plot of claim 18, wherein said stake lights having a stake comprising a material selected from a group consisting of a stainless steel, and an iron.

20. The method for illuminating a burial plot of claim 17, wherein said stake lights having a shaped body comprising a material selected from a group consisting of a silk, a polyvinyl chloride, and an acrylonitrile butadiene styrene.
